(19) United States
(12) Patent Application Publication
(10) Pub. No.: US 2012/0192120 A1
(43) Pub. Date: Jul. 26, 2012

(54) IMAGE FORMING APPARATUS AND TERMINAL DEVICE EACH HAVING TOUCH PANEL

(75) Inventors: Takehisa Yamaguchi, Ikoma-shi (JP); Toshimichi Iwai, Kitakatsuragi-gun (JP); Kazumi Sawayanagi, Itami-shi (JP); Tomo Tsuboi, Itami-shi (JP); Akihiro Torigoshi, Amagasaki-shi (JP)

(73) Assignee: Konica Minolta Business Technologies, Inc., Tokyo (JP)

(21) Appl. No.: 13/358,261

(22) Filed: Jan. 25, 2012

(30) Foreign Application Priority Data
Jan. 25, 2011 (JP) 2011-012629

(51) Int. Cl. G06F 3/033; G06F 3/041

(52) U.S. Cl. 715/863

(57) ABSTRACT

An image forming apparatus includes a touch panel, a controller connected to the touch panel, and a memory. When a pinch-in gesture on the touch panel is detected during execution of an application, the controller stores, in the memory, information showing a state of processing of the application when the pinch-in gesture is detected, and when a pinch-out gesture on the touch panel is detected, the controller reads the stored information showing the state of processing of the application from the memory, and resumes processing of the application from the state shown by the information.

This application is based on Japanese Patent Application No. 2011-012629 filed with the Japan Patent Office on Jan. 25, 2011, the entire content of which is hereby incorporated by reference.

### BACKGROUND OF THE INVENTION

1. Field of the Invention

The present invention relates to an image forming apparatus and a terminal device, and more particularly to an image forming apparatus and a terminal device in which operations are executed by user's “pinch-in (pinch-close)” and “pinch-out (pinch-open)” gestures on a touch panel.

2. Description of the Related Art

When an image forming apparatus, such as a copier, a printer or their compound machine, MFP (Multi-Functional Peripheral), and another device such as a portable terminal, for example, are connected to a network, an envisaged use is to transmit and receive data between these devices through the network.

Conventionally, when transmitting data between such an image forming apparatus and another device through a network, operations or manipulations of selecting data to be transmitted in a device on the transmitting side, and then selecting a destination device on the receiving side referring to the network are necessary. This imposes a complicated manipulation on a user, requires the address of a destination to be identified, and is troublesome.

For example, Japanese Laid-Open Patent Publication No. 2009-276957 discloses a system in which login information previously registered is automatically entered into a login screen to execute automatic login, wherein a drag-and-drop operation is performed for an icon for registering login information to the login screen, thereby acquiring screen information of the login screen, and registering that information and entered information as login information. Moreover, for example, Japanese Laid-Open Patent Publication No. 2007-304669 discloses a control technique for moving a file to a function setting area by a drag-and-drop operation, so that a process set up for the area is automatically executed for that file.

Then, it is supposed that a drag-and-drop operation as disclosed in these pieces of literature is employed for data transmission.

However, the drag-and-drop operation requires an area presenting a destination to be previously displayed, which may be complicated for a user who is unfamiliar with an operation therefor. Moreover, on a display unit whose display area is narrow provided for an image forming apparatus, a display screen will be complicated by displaying an area presenting a destination, which may cause a complicated operation. Then, as a result, data transmission cannot be made by continuous and intuitive manipulations.

### SUMMARY OF THE INVENTION

The present invention was made in view of such problems, and has an object to provide an image forming apparatus and a terminal device capable of transmitting data with continuous and intuitive manipulations between the devices connected through a network.

To achieve the above-described object, according to an aspect of the present invention, an image forming apparatus includes a touch panel, a controller connected to the touch panel, and a memory. Continuously after two contacts are made on the touch panel, when a first gesture of moving the two contacts in a direction that a spacing therebetween is decreased and then releasing the two contacts after being moved is detected during execution of a first application, the controller stores information showing a state of processing of the first application when the first gesture is detected, in the memory, and when a second gesture of moving the two contacts in a direction that the spacing therebetween is increased and then releasing the two contacts after being moved is detected on the touch panel, the controller reads the stored information showing the state of processing of the first application from the memory, and resumes processing of the first application from the state shown by the stored information.

Preferably, the image forming apparatus further includes a communication device for communicating with an other device. When the first gesture is detected during execution of the first application, the controller outputs a command for causing the other device previously stored to execute a second application previously defined in correspondence with the first application, and when the second gesture is detected, the controller sends a request for information from the other device to acquire the information transmitted from the other device in response to the request, and resumes processing of the first application using the information.

More preferably, the controller outputs the command in accordance with the state of processing of the first application when the first gesture is detected.

More preferably, the controller outputs a command for causing the second application to be executed to request information corresponding to a position where the first gesture has been performed on a screen in accordance with execution of the first application when the first gesture is detected, and when the second gesture is detected, the controller inputs the information acquired from the other device to a position on the first application corresponding to the position where the first gesture has been performed, and resumes processing of the first application.

Preferably, the controller performs user authentication using user information to store, in the memory, the information showing the state of processing of the first application in association with a user. The information transmitted from the other device has a user associated therewith. When the second gesture is detected, the controller resumes processing of the first application using the information acquired from the other device in a case where the user associated with the information showing the state of processing of the first application matches the user associated with the information acquired from the other device.

Preferably, upon receipt of input of the command from the other device and when the second gesture is detected during execution of the second application indicated by the command, the controller identifies information displayed in an area defined by the two contacts at least either of before and after being moved as information to be transmitted to the other device, and transmits the information to the other device.

Preferably, the controller performs user authentication using user information to store, in the memory, the information showing the state of processing of the first application in association with a user, and when the second gesture is detected, the controller resumes processing of the first application in a case where a login user in the second gesture matches the user associated with the information showing the state of processing of the first application.

According to another aspect of the present invention, a terminal device includes a touch panel, a controller connected to the touch panel, and a communication device for communicating with an image forming apparatus. Continuously after two contacts are made on the touch panel, when a first gesture of moving the two contacts in a direction that a spacing therebetween is decreased and then releasing the two contacts after being moved is detected during execution of a first application, the controller identifies information displayed by execution of the first application in an area defined by the two contacts at least either of before and after being moved as information to be transmitted, and outputs the information to be transmitted to the image forming apparatus.

Preferably, continuously after two contacts are made on the touch panel, when a second gesture of moving the two contacts in a direction that the spacing therebetween is increased and then releasing the two contacts after being moved is detected, the controller accesses the image forming apparatus previously stored to acquire a command at least identifying a second application to be executed from the image forming apparatus, and executes the second application in accordance with the command.

Preferably, continuously after two contacts are made on the touch panel, when a second gesture of moving the two contacts in a direction that the spacing therebetween is increased and then releasing the two contacts after being moved is detected, the controller accesses the image forming apparatus previously stored to request the information to be transmitted from the image forming apparatus.

According to still another aspect of the present invention, an image forming system includes an image forming apparatus and a terminal device. The image forming apparatus and the terminal device each include a touch panel and a controller connected to the touch panel. Continuously after two contacts are made on the touch panel, when a first gesture of moving the two contacts in a direction that a spacing therebetween is decreased and then releasing the two contacts after being moved is detected during execution of a first application, the controller of a first device out of the image forming apparatus and the terminal device stores information showing a state of processing of the first application when the first gesture is detected, and outputs a command for causing a second device out of the image forming apparatus and the terminal device to execute a second application previously defined in correspondence with the first application, and when a second gesture of moving the two contacts in a direction that the spacing therebetween is increased and then releasing the two contacts after being moved is detected on the touch panel, the controller of the first device sends a request for information from the second device to acquire the information transmitted from the second device in response to the request, and using the information, resumes processing of the first application from the state shown by the stored information showing the state of processing of the first application.

Preferably, the first device further includes a communication device for communicating with the second device. When the first gesture is detected during execution of the first application, the controller of the first device outputs the command for causing the second device previously stored to execute the second application, and when the second gesture is detected, the controller of the first device sends a request for information from the second device to acquire the information transmitted from the second device in response to the request, and resumes processing of the first application using the information.

Preferably, the controller of the first device outputs the command in accordance with the state of processing of the first application when the first gesture is detected.

More preferably, the controller of the first device outputs a command for causing the second application to be executed to request information corresponding to a position where the first gesture has been performed on a screen in accordance with execution of the first application when the first gesture is detected, and when the second gesture is detected, the controller of the first device inputs the information acquired from the second device to a position on the first application corresponding to the position where the first gesture has been performed, and resumes processing of the first application.

Preferably, the controller of the first device performs user authentication using user information to store the information showing the state of processing of the first application in association with a user. The information transmitted from the second device has a user associated therewith. When the second gesture is detected, the controller of the first device resumes processing of the first application using the information acquired from the second device in a case where the user associated with the information showing the state of processing of the first application matches the user associated with the information acquired from the second device.

Preferably, upon receipt of input of the command from the second device and when the second gesture is detected during execution of the second application indicated by the command, the controller of the first device identifies information displayed in an area defined by the two contacts at least either of before and after being moved as information to be transmitted to the second device, and transmits the information to the second device.

Preferably, the controller of the first device performs user authentication using user information to store the information showing the state of processing of the first application in association with a user, and when the second gesture is detected, the controller of the first device resumes processing of the first application in a case where a login user in the second gesture matches the user associated with the information showing the state of processing of the first application.

According to a further aspect of the present invention, a non-transitory computer-readable storage medium having recorded thereon a program for causing an image processing apparatus having a touch panel and a controller connected to the touch panel to execute a first application. The program instructs the controller to perform the following steps of continuously after two contacts are made on the touch panel, detecting a first gesture of moving the two contacts in a direction that a spacing therebetween is decreased and then releasing the two contacts after being moved during execution of the first application, when the first gesture is detected during execution of the first application, storing information showing a state of processing of the first application when the first gesture is detected, and outputting a command for causing an other device to execute a second application previously defined in correspondence with the first application, after detection of the first gesture, detecting a second gesture of moving the two contacts in a direction that the spacing therebetween is increased and then releasing the two contacts after being moved, when the second gesture is detected after the detection of the first gesture, sending a request for information from the other device, acquiring the information transmitted from the other device in response to the request, and resuming processing of the first application from the state shown by the stored information, using the information acquired from the other device.

According to a still further aspect of the present invention, a non-transitory computer-readable storage medium having recorded thereon a program for causing a terminal device having a touch panel and a controller connected to the touch panel to execute a process of transmitting information stored in the terminal device to an image processing apparatus. The program instructs the controller to perform the following steps of continuously after two contacts are made on the touch panel, detecting a first gesture of moving the two contacts in a direction that a spacing therebetween is increased and then releasing the two contacts after being moved, reporting detection of the first gesture to the image processing apparatus, thereby acquiring a command from the image processing apparatus, executing an application identified by the command, during execution of the application, continuously after two contacts are made on the touch panel, detecting a second gesture of moving the two contacts in a direction that the spacing therebetween is decreased and then releasing the two contacts after being moved, when the second gesture is detected, identifying information displayed by execution of the application in an area defined by the two contacts at least either of before and after being moved as information to be transmitted, and outputting the information to be transmitted to the image processing apparatus in response to a request from the image processing apparatus.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a specific example of a configuration of an image forming system according to an embodiment.

FIG. 2 shows a specific example of a hardware configuration of MFP (Multi-Functional Peripheral) included in the image forming system.

FIG. 3 shows a specific example of a hardware configuration of a portable terminal included in the image forming system.

FIG. 4 shows the outline of operations in the image forming system according to a first embodiment.

FIG. 5 illustrates a pinch-in gesture.

FIG. 6 illustrates a pinch-out gesture.

FIG. 7 is a block diagram showing a specific example of a functional configuration of a portable terminal according to the first embodiment.

FIG. 8 is a sequence diagram showing the flow of operations in the image forming system according to the first embodiment.

FIG. 9 is a flow chart showing an operation in a portable terminal on the transmitting side.

FIG. 10 is a flow chart showing an operation in a portable terminal on the receiving side.

FIG. 11 is a flow chart showing an operation in MFP.

FIG. 12 shows the outline of operations in the image forming system according to a second embodiment.

FIG. 13 is a sequence diagram showing the flow of operations in the image forming system according to the second embodiment.

FIG. 14 is a block diagram showing a specific example of a functional configuration of MFP according to the second embodiment.

FIG. 15 is a flow chart showing an operation in MFP in response to a pinch-in gesture.

FIG. 16 is a flow chart showing an operation in the portable terminal.

FIG. 17 is a flow chart showing an operation in MFP in response to a pinch-out gesture.

FIG. 18 illustrates variations of data transmission according to the present embodiment.

FIGS. 19 to 23 each illustrate a specific example of a method of identifying an icon indicated by the pinch-in gesture.

### DESCRIPTION OF THE PREFERRED EMBODIMENTS

Hereinafter, embodiments of the present invention will be described with reference to the drawings. In the following description, like parts and components are denoted by like reference characters. They are named and function identically as well.

<System Configuration>

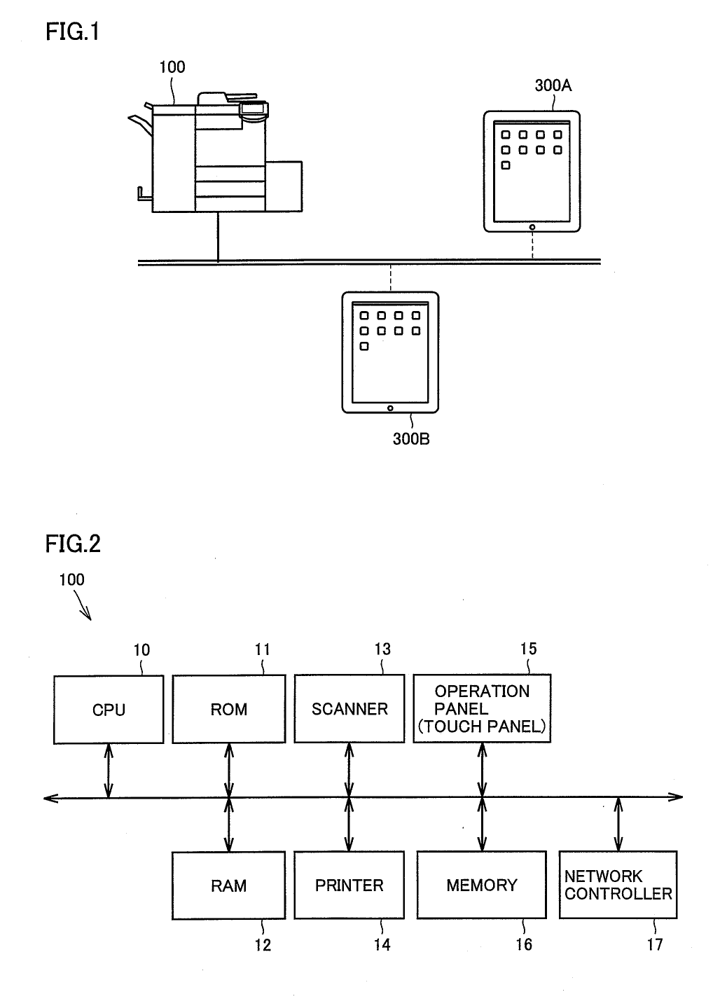

FIG. 1 shows a specific example of a configuration of an image forming system according to the present embodiment.

Referring to FIG. 1, the image forming system according to the present embodiment includes an MFP (Multi-Functional Peripheral) 100 as an example of an image forming apparatus and a plurality of portable terminals 300A, 300B as terminal devices. They are connected through a network, such as LAN (Local Area Network). The plurality of portable terminals 300A, 300B will be collectively referred to as a portable terminal 300.

The network may be wired or may be wireless. As an example, as shown in FIG. 1, MFP 100 is connected to a wired LAN, and portable terminal 300 is connected to the wired LAN through a wireless LAN.

<Configuration of MFP>

FIG. 2 shows a specific example of a hardware configuration of MFP 100.

Referring to FIG. 2, MFP 100 includes a CPU (Central Processing Unit) 10 as an arithmetic device for overall control, a ROM (Read Only Memory) 11 for storing programs and the like to be executed by CPU 10, a RAM (Random Access Memory) 12 for functioning as a working area during execution of a program by CPU 10, a scanner 13 for optically reading a document placed on a document table not shown to obtain image data, a printer 14 for fixing image data on a printing paper, an operation panel 15 including a touch panel for displaying information and receiving an operation input to MFP 100 concerned, a memory 16 for storing image data as a file, and a network controller 17 for controlling communications through the above-described network.

Operation panel 15 includes the touch panel and an operation key group not shown. The touch panel is composed of a display device such as a liquid crystal display and a pointing device such as an optical touch panel or a capacitance touch panel, the display device and the pointing device overlapping each other, and displays an operation screen so that an indicated position on the operation screen is identified. CPU 10 causes the touch panel to display the operation screen based on data stored previously for causing screen display.

The indicated position (position of touch) on the touch panel as identified and an operation signal indicating a pressed key are input to CPU 10. CPU 10 identifies details of manipulation based on the pressed key or the operation screen being displayed and the indicated position, and executes a process based thereon.

<Configuration of Portable Terminal>

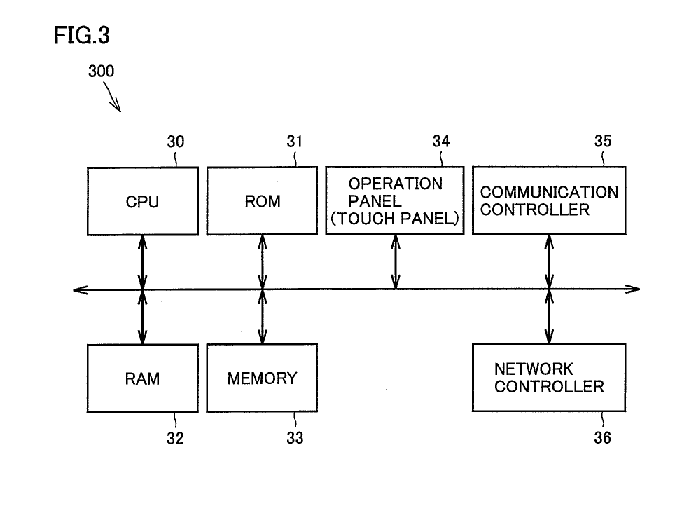

FIG. 3 shows a specific example of a hardware configuration of portable terminal 300.

Referring to FIG. 3, portable terminal 300 includes a CPU 30 as an arithmetic device for overall control, a ROM 31 for storing programs and the like to be executed by CPU 30, a RAM 32 for functioning as a working area during execution of a program by CPU 30, a memory 33 for storing image data as a file or storing another type of information, an operation panel 34 including a touch panel for displaying information and receiving an operation input to portable terminal 300 concerned, a communication controller 35 for controlling communications through telephone lines by communicating with a base station not shown, and a network controller 36 for controlling communications through the above-described network.

Operation panel 34 may have a configuration similar to that of operation panel 15 of MFP 100. That is, as an example, operation panel 34 includes a touch panel composed of a display device such as a liquid crystal display and a pointing device such as an optical touch panel or a capacitance touch panel, the display device and the pointing device overlapping each other.

CPU 30 causes the touch panel to display an operation screen based on data stored previously for causing screen display. On the touch panel, the indicated position on the operation screen is identified, and an operation signal showing that position is input to CPU 30. CPU 30 identifies details of manipulation based on the operation screen being displayed and the indicated position, and executes a process based thereon.

### First Embodiment

<Outline of Operations>

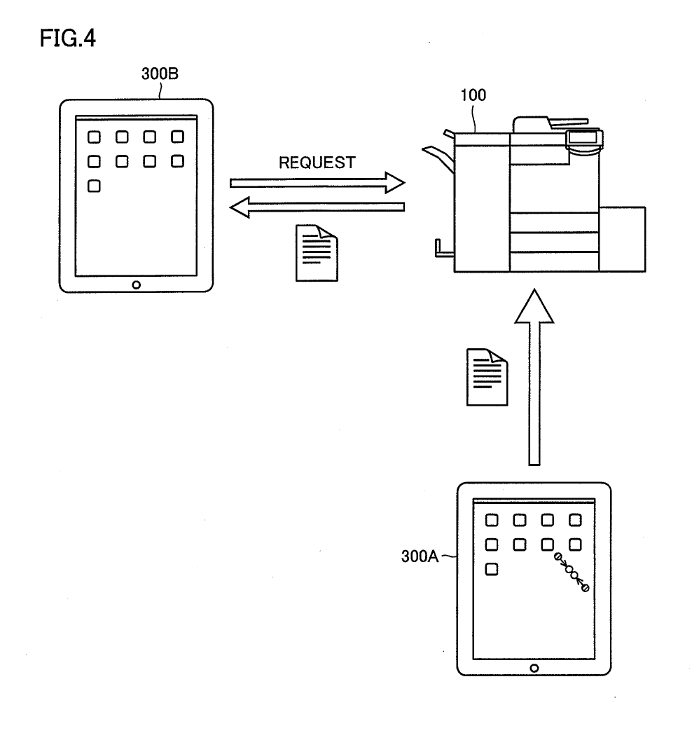

FIG. 4 shows the outline of operations in the image forming system according to a first embodiment. In the image forming system according to the first embodiment, an operation for transmitting data to be transmitted (as an example, a document) from portable terminal 300A to portable terminal 300B is performed.

Specifically, referring to FIG. 4, in the state where icons presenting documents stored are displayed on operation panel 34 of portable terminal 300A, when it is detected that a “pinch-in” gesture has been performed on at least one icon, a document presented by that icon is identified as a document to be transmitted, and is transmitted to MFP 100.

When a transmission request for that document is made from portable terminal 300B to MFP 100, the document is output from MFP 100 to portable terminal 300B.

The document stored in portable terminal 300A is thereby transmitted to portable terminal 300B through MFP 100.

FIG. 5 illustrates a “pinch-in” gesture. Referring to FIG. 5, the “pinch-in” or pinching gesture refers to a motion of making two contacts P1 and P2 on operation panel 15 using, for example, two fingers or the like, and then moving the fingers closer to each other from their initial positions linearly or substantially linearly, and releasing the two fingers from operation panel 15 at two contacts P′l and P′2 moved closer.

When it is detected that two contacts P1 and P2 on operation panel 15 have been made simultaneously, and further, the respective contacts have been continuously displaced from their initial positions linearly or substantially linearly, and both the contacts have been released almost simultaneously at two contacts P′1 and P′2 positioned at a spacing narrower than the spacing between their initial positions, CPU 10 detects that the “pinch-in” gesture has been performed.

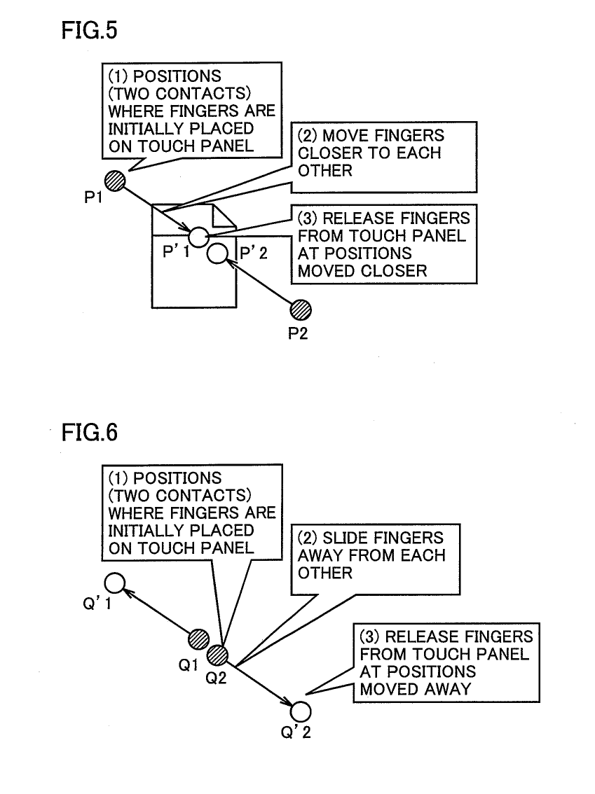

FIG. 6 illustrates a “pinch-out” gesture. Referring to FIG. 6, the “pinch-out” or anti-pinching gesture refers to a motion of making two contacts Q1 and Q2 on operation panel 34 using, for example, two fingers or the like, and then moving the fingers away from their initial positions linearly or substantially linearly, and releasing the two fingers from operation panel 34 at two contacts Q′1 and Q′2 moved away to some degree.

When it is detected that two contacts Q1 and Q2 on operation panel 34 have been made simultaneously, and further, the respective contacts have been continuously displaced from their initial positions linearly or substantially linearly, and both the contacts have been released almost simultaneously at two contacts Q′1 and Q′2 positioned at a spacing wider than the spacing between their initial positions, CPU 30 detects that the “pinch-out” or de-pinching gesture has been performed.

<Functional Configuration>

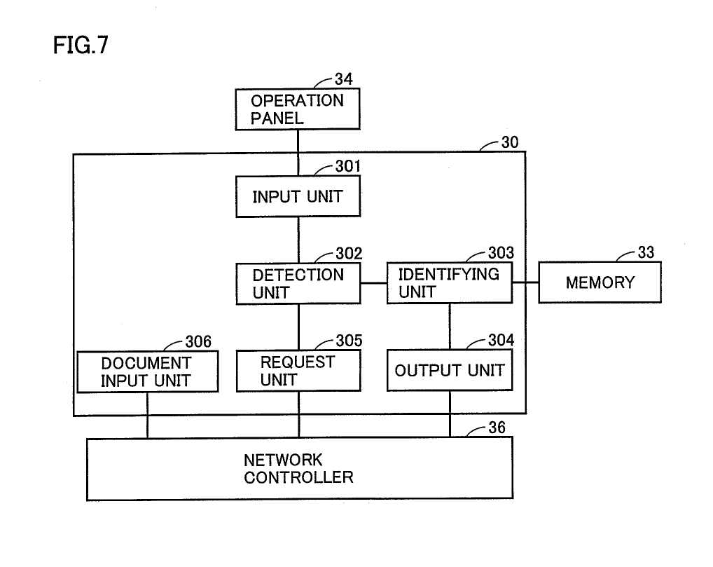

FIG. 7 is a block diagram showing a specific example of a functional configuration of portable terminal 300 for achieving operations as described in the Outline of Operations in the image forming system according to the first embodiment. Each function shown in FIG. 7 is a function mainly configured in CPU 30 by CPU 30 reading a program stored in ROM 31 and executing the program on RAM 32. However, at least some functions may be configured by the hardware configuration shown in FIG. 3.

Referring to FIG. 7, as functions for achieving the above-described operations, portable terminal 300 includes an input unit 301 for receiving input of operation signals indicating instructions on operation panel 34, a detection unit 302 for detecting the above-described pinch-in and pinch-out gestures based on the operation signals, an identifying unit 303 for identifying a position indicated by the pinch-in gesture based on the indicated position presented by the operation signal, an output unit 304 previously storing access information on MFP 100 as an output destination, and using this access information, outputting a document identified from among documents stored in memory 33 to MFP 100 through network controller 36, a request unit 305 previously storing access information on MFP 100 as a requester, and using this access information, outputting a document transmission request to MFP 100 through network controller 36 in response to detection of a pinch-out gesture, and a document input unit 306 for receiving input of a document from MFP 100 through network controller 36.

Identifying unit 303 identifies an icon, displayed in an area defined based on at least either two contacts (two contacts P1, P2 in FIG. 5) indicated initially in the pinch-in gesture or two contacts (two contacts P′1, P2 in FIG. 5) indicated finally, as an icon indicated by the pinch-in gesture.

The method of identifying an icon indicated by the pinch-in gesture in identifying unit 303 is not limited to a certain method. FIGS. 19 to 23 each illustrate a specific example of a method of identifying an icon indicated by the pinch-in gesture in identifying unit 303.

As an example, as shown in FIG. 19, identifying unit 303 may identify a rectangle in which two contacts P1 and P2 indicated initially are at opposite corners as an area defined by the pinch-in gesture, and may identify icons, each of which is at least partially included in that rectangle, may be identified as indicated icons. Alternatively, as shown in FIG. 20, a rectangle in which two contacts P1 and P2 indicated initially are at opposite corners may be identified as an area defined by the pinch-in gesture, and icons completely included in that rectangle may be identified as indicated icons. With such identification, the user can indicate an intended document by touching operation panel 34 with two fingers so as to sandwich an icon presenting a document to be transmitted, and performing a motion for the pinch-in gesture from that state. The document to be transmitted can thus be indicated in an intuitive manner. Even when an icon image is small, it can be indicated correctly.

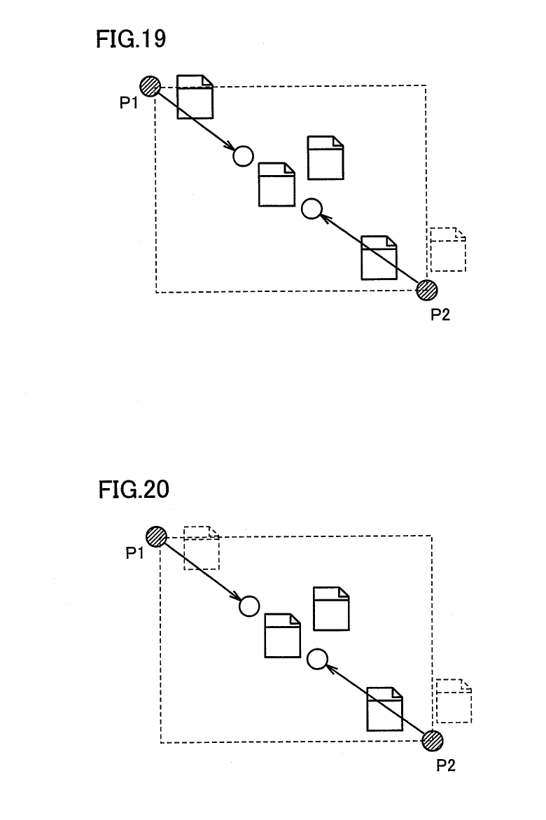

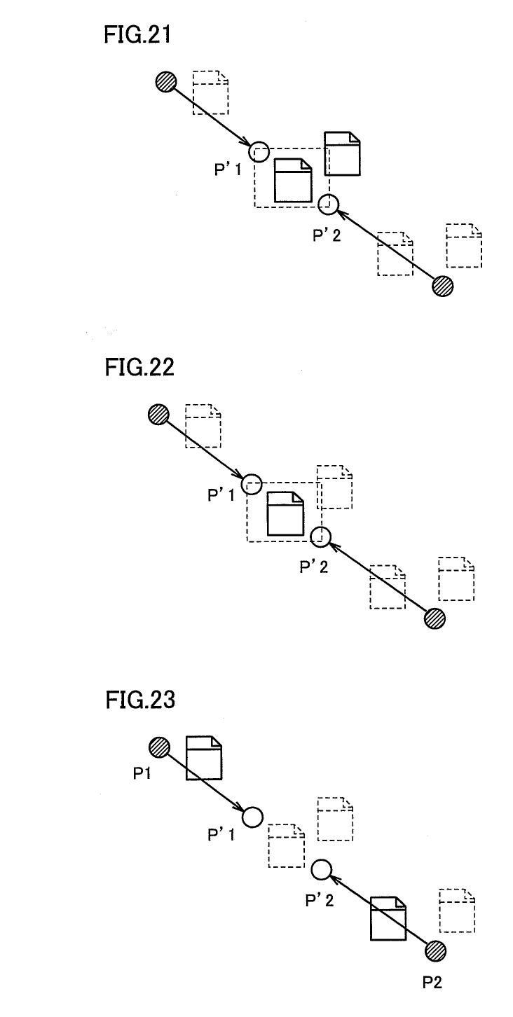

As another example, as shown in FIG. 21, identifying unit 303 may identify a rectangle in which two contacts P′1 and P′2 indicated finally are at opposite corners as an area defined by the pinch-in gesture, and may identify icons, each of which is at least partially included in that rectangle, may be identified as indicated icons. Alternatively, as shown in FIG. 22, a rectangle in which two contacts P′1 and P′2 indicated finally are at opposite corners may be identified as an area defined by the pinch-in gesture, and an icon completely included in that rectangle may be identified as an indicated icon. With such identification, the user can indicate an intended document by touching operation panel 34 with two fingers spaced apart, and then moving them closer to each other so that an icon presenting a document to be transmitted is sandwiched finally between the two fingers. The document to be transmitted can thus be indicated in an intuitive manner. Even when an icon image is small, it can be indicated correctly.

As still another example, as shown in FIG. 23, identifying unit 303 may identify two lines that connect two contacts P1, P2 indicated initially and two contacts P′1, P′2 indicated finally, respectively, as areas defined by the pinch-in gesture, and may identify icons where either one line overlaps as indicated icons. With such identification, the user can indicate an intended document by moving the two fingers so as to pinch in an icon presenting a document to be transmitted. The document to be transmitted can thus be indicated in an intuitive manner. Even when an icon image is small, it can be indicated correctly.

<Flow of Operations>

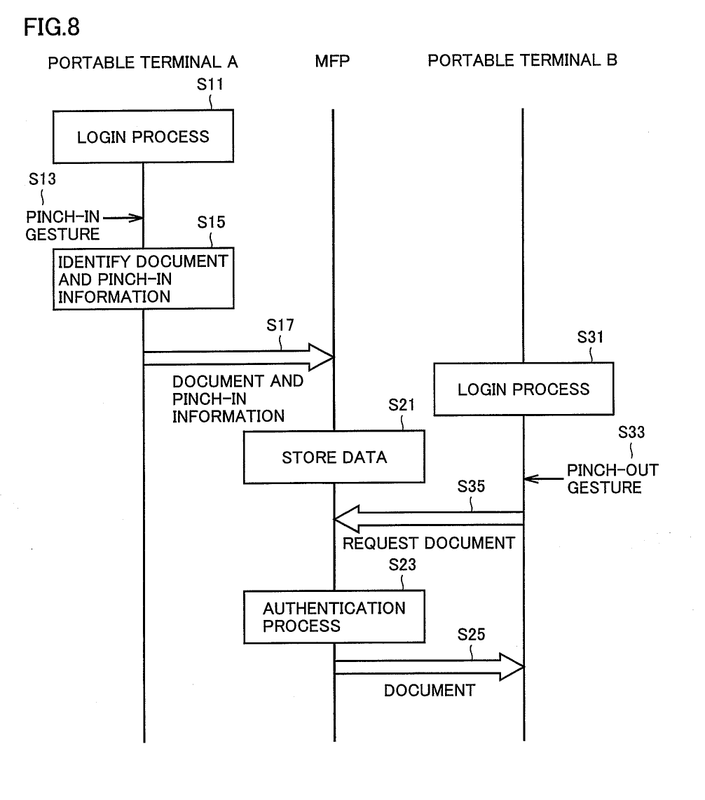

FIG. 8 is a sequence diagram showing the flow of operations in the image forming system according to the first embodiment.

Referring to FIG. 8, in Step S11, a login process is performed in portable terminal 300A denoted by a portable terminal A, and user authentication is carried out. Then, when a pinch-in gesture is detected in Step S13, a document indicated by the pinch-in gesture in portable terminal 300A is identified in Step S15. Further, information that identifies the date and time when the pinch-in gesture is detected, information that identifies a login user when the pinch-in gesture is detected, information that identifies the order in which identified documents have been indicated by the pinch-in gesture, and the like are identified as information related to the pinch-in gesture. These pieces of information related to the pinch-in gesture will be also referred to as “pinch-in information” in the following description.

Portable terminal 300A previously stores MFP 100 as an output destination, and in Step S17, the document to be transmitted and the pinch-in information identified in the above-described Step S15 are transmitted to MFP 100.

MFP 100, upon receipt of this information, temporarily stores, in Step S21, the transmitted document as a document to be transmitted. This “temporary” period is previously set at 24 hours, for example, and when there is no transmission request, which will be described later, received from another device after the lapse of that period, identification to be transmitted may be cancelled. Further, when there is no transmission request received within the above-described temporary period, MFP 100 may cause operation panel 15 to display a warning reading that transmission has not been completed, instead of or in addition to cancellation of identification to be transmitted, or may transmit a message to that effect to portable terminal 300A or 300B stored in correspondence with the user associated with the document to be transmitted.

As another example of canceling identification to be transmitted, MFP 100 may delete a document and cancel identification to be transmitted by receiving a report from portable terminal 300A that a pinch-in gesture is detected again on a folder in which the icon of the document indicated to be transmitted has been displayed, instead of the case when there is no transmission request received within the above-described temporary period or in addition to the case when there is no transmission request.

In Step S31, a login process is performed in portable terminal 300B presented as a portable terminal B, and user authentication is carried out. Portable terminal 300B previously stores MFP 100 as a requester, and when a pinch-out gesture is detected in Step S33, a document transmission request is sent from portable terminal 300B to MFP 100 in Step S35.

MFP 100, upon receipt of this request, performs an authentication process in Step S23, and when authentication has succeeded, outputs the document temporarily stored as a document to be transmitted in the above-described step S21 to portable terminal 300B.

In the above-described step S23, authentication may be determined as successful when user information included in pinch-in information transmitted together with the document from portable terminal 300A agrees with user information included in the document transmission request in the above-described step S35, or a correspondence between portable terminal 300A and portable terminal 300B may be stored previously, and authentication may be determined as successful when the transmission request has been made from portable terminal 300B. Alternatively, pinch-in information may include a password, and authentication may be determined as successful when the password agrees with a password included in the document transmission request in the above-described step S35.

Hereinbelow, the operation in each device will be described.

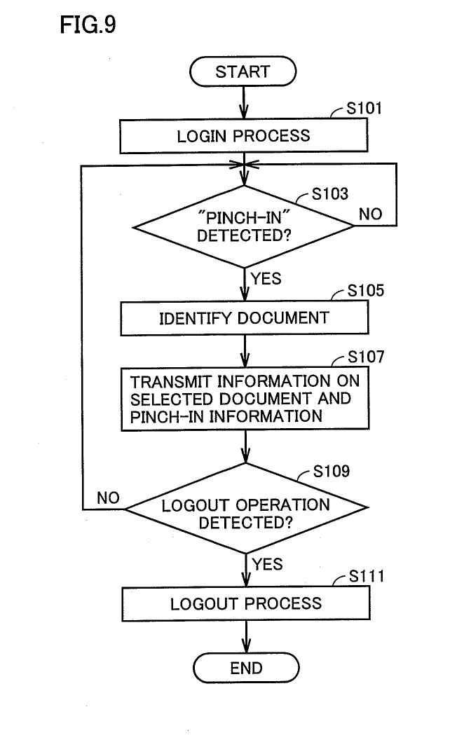

FIG. 9 is a flow chart showing an operation in portable terminal 300A. The operation shown in the flow chart of FIG. 9 is implemented by CPU 30 reading a program stored in ROM 31 and executing the program on RAM 32.

Referring to FIG. 9, in Step S101, CPU 30 executes a login process by receiving a login operation. Then, when it is detected that the pinch-in gesture has been performed on a screen of operation panel 34 where an icon presenting a stored document is displayed (YES in Step S103), CPU 30, in Step 5105, identifies the document indicated by that gesture, and further, identifies the above-described pinch-in information. In Step S107, CPU 30 transmits the identified document, associated with the pinch-in information, to MFP 100 previously stored as an output destination.

The above operation is repeated until a logout operation is detected (NO in Step S109). Therefore, a plurality of documents may be identified as documents to be transmitted by the above-described operation performed several times until a logout operation is detected. Alternatively, a plurality of documents may be identified as documents to be transmitted in correspondence with the pinch-in gesture performed on a folder or on a plurality of documents.

When a logout operation is detected (YES in Step S109), CPU 30 executes a logout process in Step S111, and terminates the sequential processing of identifying a document to be transmitted.

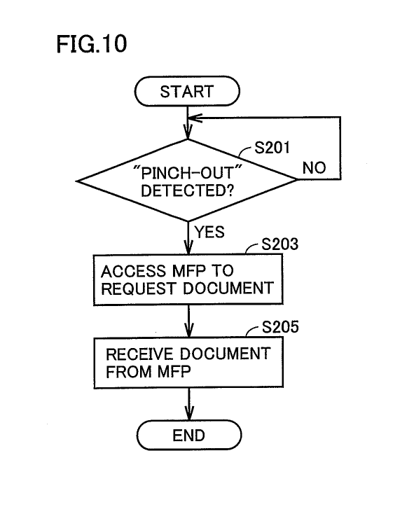

FIG. 10 is a flow chart showing an operation in a portable terminal 300B. The operation shown in the flow chart of FIG. 10 is also implemented by CPU 30 reading a program stored in ROM 31 and executing the program on RAM 32.

Referring to FIG. 10, when it is detected that the pinch-out gesture has been performed on operation panel 34 (YES in Step S203), CPU 30 in Step 5203 outputs a transmission request to MFP 100 previously stored as an output destination. This transmission request may be data previously arranged with MFP 100.

When a document is transmitted from MFP 100 in response to the request, CPU 30 receives the document in Step S205, and terminates the sequential processing of acquiring a document to be transmitted.

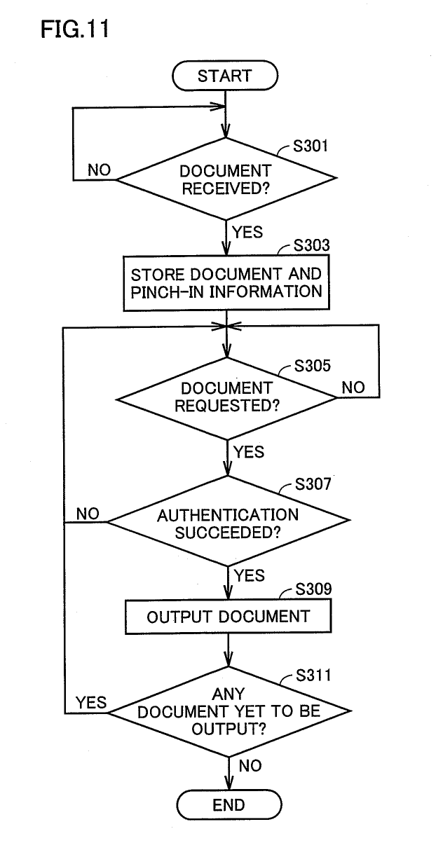

FIG. 11 is a flow chart showing an operation in MFP 100. The operation shown in the flow chart of FIG. 11 is implemented by CPU 10 reading a program stored in ROM 11 and executing the program on RAM 12.

Referring to FIG. 11, upon receipt of a document from MFP 300A (YES in Step S301), CPU 10 in Step S303 stores that document in a storage area previously defined, in association with the pinch-in information received together. Then, upon receipt of a document transmission request (YES in Step S305), CPU 10 performs authentication for each document stored in the above-described storage area. As a result, when authentication has succeeded (YES in Step S307), CPU 10 in Step S309 outputs a document to be transmitted for which authentication has succeeded, to MFP 300B.

The above operation is repeated for every document stored in the above-described storage area (NO in Step S311). That is, when a plurality of documents are stored in the above-described storage area, authentication process is performed for each document, and authenticated documents are output to portable terminal 300B. Therefore, when a plurality of documents are transmitted from portable terminal 300A as documents to be transmitted, the plurality of documents will be output to portable terminal 300B in response to the transmission request from portable terminal 300B.

<Effects of Embodiment>

By the above-described operations executed in the image forming system according to the first embodiment, a document of concern will be transmitted from portable terminal 300A to portable terminal 300B by continuous and intuitive manipulations such as performing a pinch-in gesture on portable terminal 300A as a document source and performing a pinch-out gesture on portable terminal 300B as a destination.

Therefore, the user is not required to perform an operation of indicating a destination when indicating a document, and he/she is not required to perform an operation of indicating a source when requiring transmission, so that the document can be transmitted easily by intuitive and continuous manipulations.

<Variation>

It is noted that, in the above description, the document shall be transmitted from portable terminal 300A to portable terminal 300B through MFP 100. That is, MFP 100 shall function as a server. However, the function of the server may be included in one portable terminal 300. Namely, when the server function is included in portable terminal 300A, portable terminal 300A may temporarily store an identified document as a document to be transmitted in a previously defined storage area, and a transmission request may be directly transmitted from portable terminal 300B to portable terminal 300A, thereby directly transmitting the document from portable terminal 300A to portable terminal 300B. Alternatively, when the server function is included in portable terminal 300B, a document identified in portable terminal 300A may be directly transmitted to portable terminal 300B and temporarily stored as a target to be transmitted in a previously defined storage area, and when a pinch-out gesture in portable terminal 300B is detected, the temporarily stored document may be taken out from the storage area as a document to be processed.

### Second Embodiment

<Outline of Operations>

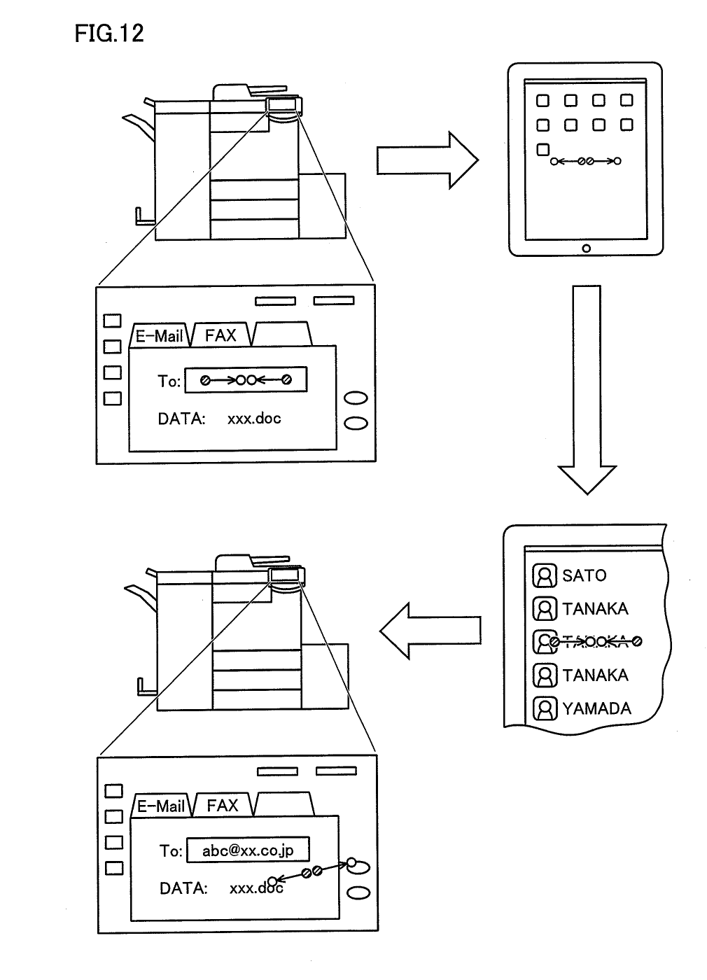

FIG. 12 shows the outline of operations in the image forming system according to a second embodiment. In the image forming system according to the second embodiment, when sending e-mail from MFP 100, an operation for transmitting address information stored in portable terminal 300 from portable terminal 300 to MFP 100 for use in e-mail transmission in MFP 100 is performed.

Specifically, referring to FIG. 12, when a pinch-in gesture on an address entry field is detected on an e-mail transmission screen of MFP 100 and then a pinch-out gesture on portable terminal 300 is detected, an address book application is activated automatically in portable terminal 300. Then, when it is detected that a pinch-in gesture has been performed on at least one piece of address information displayed on an address list screen, that address information is identified as address information to be transmitted, and is transmitted to MFP 100.

Then, when it is detected that a pinch-out gesture on the e-mail transmission screen of MFP 100 has been performed, an address based on the received address information is automatically entered into the address entry field.

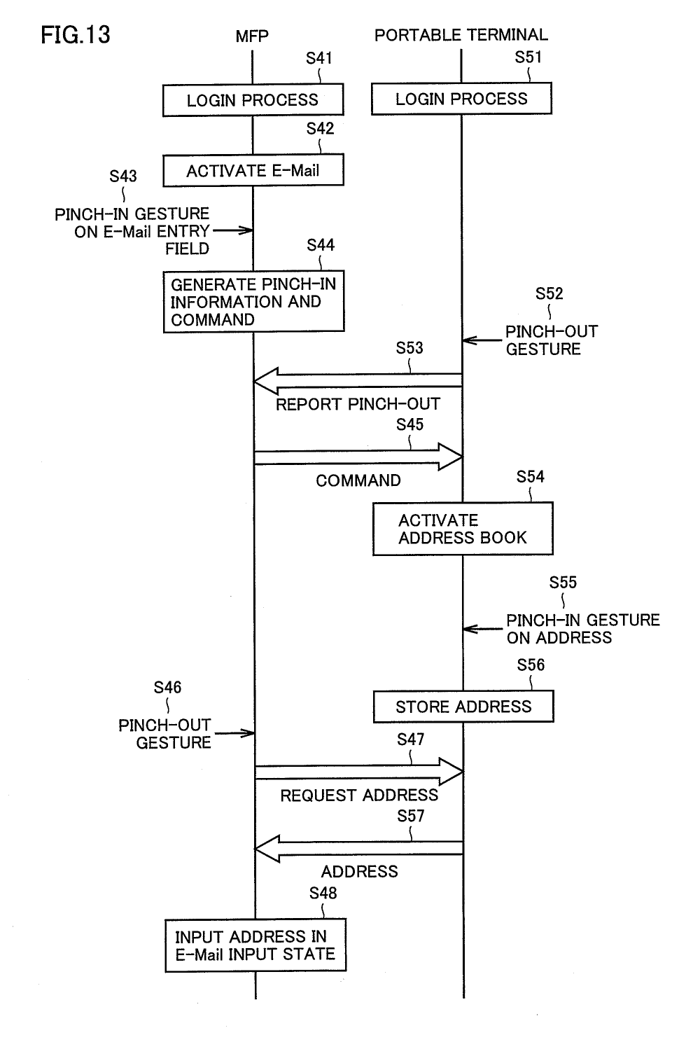

FIG. 13 is a sequence diagram showing the flow of operations in the image forming system according to the second embodiment.

Referring to FIG. 13, in Step S41, a login process is performed in MFP 100, and user authentication is carried out. Then, in Step S42, an application for e-mail transmission is activated in accordance with a user's operation, and an e-mail transmission screen is displayed. When a pinch-in gesture is detected on the address entry field on that screen in Step S43, then in Step S44, information that identifies the date and time when the pinch-in gesture is detected, information that identifies a login user when the pinch-in gesture is detected, and the like are identified as information related to the pinch-in gesture. These pieces of information related to the pinch-in gesture will also be referred to as “pinch-in information” in the following description. Further, in Step S44, a command for causing portable terminal 300 to activate the address book application is generated. This command may be one that is previously arranged between MFP 100 and portable terminal 300. The generated command is stored in association with pinch-in information.

On the other hand, in Step S51, a login process is performed in portable terminal 300, and user authentication is carried out. Portable terminal 300 previously stores MFP 100 as a report destination, and when the pinch-out gesture is detected in Step S52, portable terminal 300 in Step S35 reports MFP 100 that the gesture has been detected.

MFP 100, upon receipt of the report, transmits the command generated in Step S44 to portable terminal 300. At this time, the command may be transmitted to portable terminal 300 as a sender of the above-described report without carrying out authentication, or an authentication process may be carried out using the information that identifies the login user included in the above-described report and user information included in the pinch-in information associated with the command, and when authentication has succeeded, the command may be transmitted to portable terminal 300 previously stored as a destination.

Portable terminal 300, upon receipt of the above-described command, activates the address book application in accordance with the command in Step S54. When it is detected in Step S55 that a pinch-in gesture has been performed on address information (e.g., an icon presenting an address, etc.) displayed by the address book application, portable terminal 300 in Step S56 stores the address information subjected to the pinch-in gesture as address information to be transmitted.

MFP 100 previously stores portable terminal 300 as a requester, and when it is detected in Step S46 that the pinch-out gesture has been performed on an e-mail transmission screen displayed on MFP 100, then in Step S47, a transmission request for address information is transmitted from MFP 100 to portable terminal 300. Alternatively, the request in Step S47 may be sent to portable terminal 300 as a destination of the command in the above-described step S45.

Portable terminal 300, upon receipt of the above-described request, transmits in Step S57 the address information stored in the above-described step S56 to MFP 100. In Step S57, an authentication process is carried out using user information, login information and the like included in the address request, and when authentication has succeeded, the address information may be transmitted to MFP 100.

Upon receipt of the address information, in Step S48, MFP 100 causes an address included in the received address information to be displayed as entered into the address entry field on the e-mail transmission screen being displayed.

<Functional Configuration>

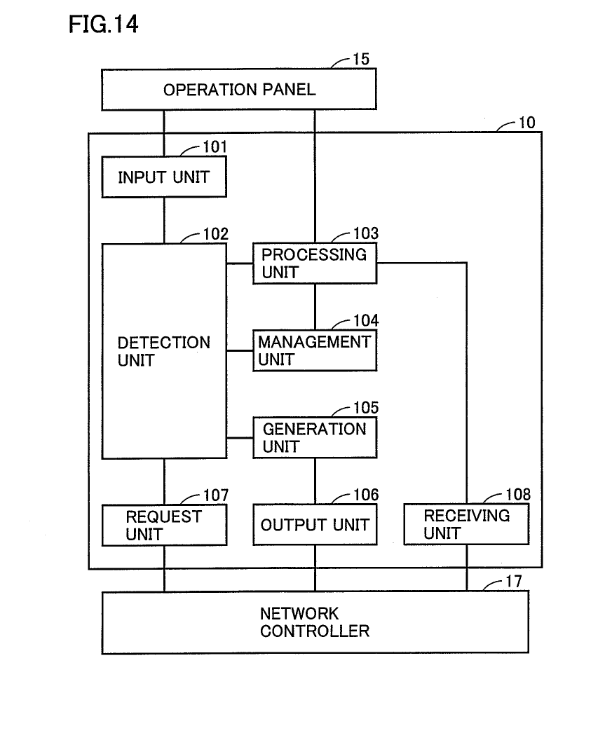

FIG. 14 is a block diagram showing a specific example of a functional configuration of MFP 100 for achieving operations as described in the Outline of Operations in the image forming system according to the second embodiment. Each function shown in FIG. 14 is a function mainly configured in CPU 10 by CPU 10 reading a program stored in ROM 11 and executing the program on RAM 12. However, at least some functions may be configured by the hardware configuration shown in FIG. 2.

Referring to FIG. 14, as functions for achieving the above-described operations, MFP 100 includes an input unit 101 for receiving input of operation signals indicating instructions on operation panel 15, a detection unit 102 for detecting the above-described pinch-in and pinch-out gestures based on the operation signals, a generation unit 105 for generating a command for causing portable terminal 300 to activate an address book application in response to a pinch-in gesture on an address entry field on an e-mail transmission screen, an output unit 106 for outputting the generated command to portable terminal 300 through network controller 17, a request unit 107 for previously storing access information on portable terminal 300 as a requester, and outputting a transmission request for the address information to portable terminal 300 through network controller 17 using the access information in response to a pinch-out gesture on the e-mail transmission screen, a receiving unit 108 for receiving input of address information from portable terminal 300 through network controller 17, a processing unit 103 for executing a process for e-mail transmission and further, entering an address based on the received address information into the address entry field and displaying the e-mail transmission screen, and a management unit 104.

Processing unit 103 is a function for executing application processing in MFP 100. When it is detected in detection unit 102 that a pinch-in gesture has been performed, management unit 104 temporarily stores the state of processing of the application being executed in processing unit 103 and information on the screen being displayed. This “temporary” period is previously set at 24 hours, for example, similarly to the first embodiment, and when there is no pinch-out gesture detected after the lapse of that period, the stored state of processing of the application may be deleted. Further, when there is no pinch-out gesture detected within the above-described temporary period, management unit 104 may cause operation panel 15 to display a warning reading that address acquisition, which will be described later, has not been performed, instead of or in addition to deletion of the stored information, or may transmit a message to that effect to portable terminal 300 stored in correspondence with the login user.

Moreover, when it is detected in detection unit 102 that a pinch-in gesture has been performed, generation unit 105 generates a command for causing portable terminal 300 to activate an application corresponding to an application being executed when the pinch-in gesture has been performed. In this example, an application for e-mail transmission is being executed when the pinch-in gesture has been performed, and the pinch-in gesture has been performed on the address entry field, so that a command for causing portable terminal 300 to activate the address book application is generated. As another example, when an application for facsimile transmission is being executed, for example, and the pinch-in gesture has been performed on a facsimile number entry field, a command for causing portable terminal 300 to activate a telephone directory application may be generated. Namely, generation unit 105 previously stores a correspondence of the application being executed when the pinch-in gesture has been performed and the position where the pinch-in gesture has been performed with an application to be activated in portable terminal 300, and identifies an application to be activated in response to the pinch-in gesture and generates a command therefor.

Further, generation unit 105 may generate a command in consideration of the state of processing at the position subjected to the pinch-in gesture. As a specific example, when the pinch-in gesture is detected with the address entry field being blank, a usual command for causing the address book application to be activated may be generated, and when the pinch-in gesture is detected with a character string entered into the address entry field, a command for causing corresponding address information to be automatically searched for using the character string as a search key may be generated in addition to the usual command for causing the address book application to be activated.

When it is detected in detection unit 102 that the pinch-in gesture has been performed, management unit 104 reads the state of processing of the application temporarily stored, and passes the read information to processing unit 103, thereby causing the processing of the application and the screen display to be resumed from that state. Request unit 107 outputs a request to transmit information in accordance with the resumed application, to portable terminal 300. In this example, since execution of the application for e-mail transmission is resumed on the way to enter an address in response to that the pinch-in gesture has been performed, a transmission request for address information is output to portable terminal 300. As another example, when execution of the application for facsimile transmission is resumed on the way to enter a facsimile number, for example, a transmission request for telephone directory information may be output to portable terminal 300. Namely, request unit 107 previously stores a correspondence of an application resumed by performing a pinch-out gesture and the state of resumed processing with information to be requested of portable terminal 300 to transmit, and identifies information to be requested in response to the application whose processing is resumed by the pinch-out gesture, and outputs a transmission request therefor.

The functional configuration of portable terminal 300 can be generally similar to the configuration depicted in FIG. 7, description of which will not be repeated here.

<Flow of Operations>

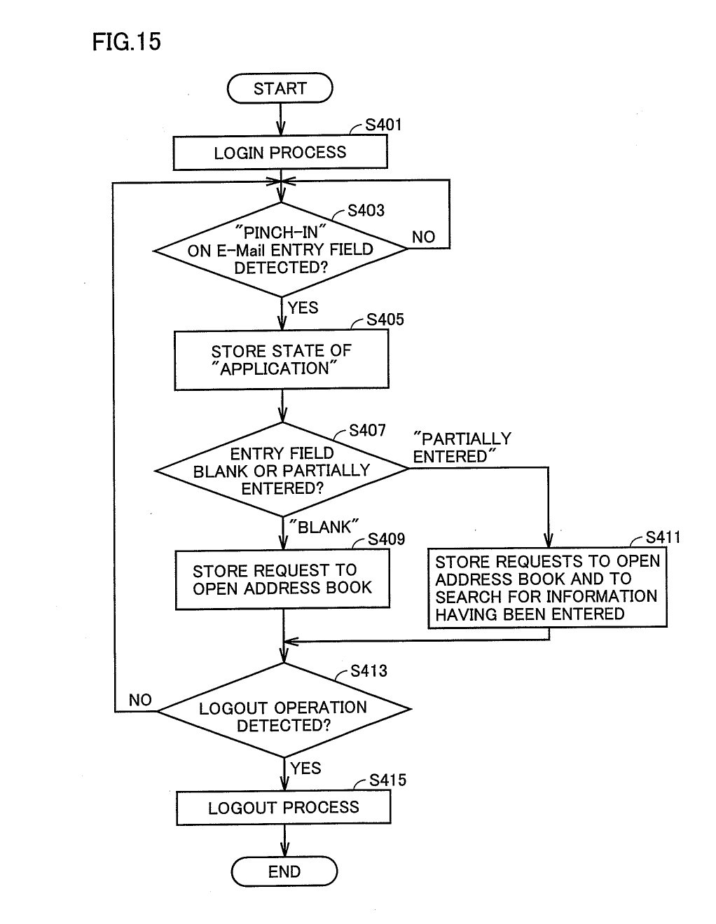

FIG. 15 is a flow chart showing an operation in MFP 100 in response to a pinch-in gesture. The operation shown in the flow chart of FIG. 15 is implemented by CPU 10 reading a program stored in ROM 11 and executing the program on RAM 12.

Referring to FIG. 15, in Step S401, CPU 10 executes a login process by receiving a login operation. Then, when the application for e-mail transmission is being executed, and when it is detected that the pinch-in gesture has been performed on the address entry field on the e-mail transmission screen displayed on operation panel 15 (YES in Step S403), CPU 10 in Step S405 stores information showing the state of processing of the application when that gesture is detected.

At this time, CPU 10 may identify information that identifies the login user, for example, as information when the pinch-in gesture has been performed, and may store that pinch-in information in association with the above-mentioned information showing the state of processing of the application.

When the address entry field having been subjected to the pinch-in gesture is blank (“blank” in Step S407), CPU 10 in Step S409 generates a command for causing portable terminal 300 to activate the address book application. When a character string has been entered into the address entry field (“partially entered” in Step S407), CPU 10 in Step S411 generates a command for causing address information to be searched for using the character string as a search key, in addition to the command for causing portable terminal 300 to activate the address book application. The generated commands are stored temporarily. At this time, CPU 10 may store the commands in association with the above-mentioned pinch-in information.

The above operation is repeated until a logout operation is detected (NO in Step S413). Therefore, a plurality of pieces of address information may be requested of portable terminal 300 by the above-described operation performed several times until a logout operation is detected.

When a logout operation is detected (YES in Step S413), CPU 10 executes a logout process in Step S415, and terminates the sequential operation.

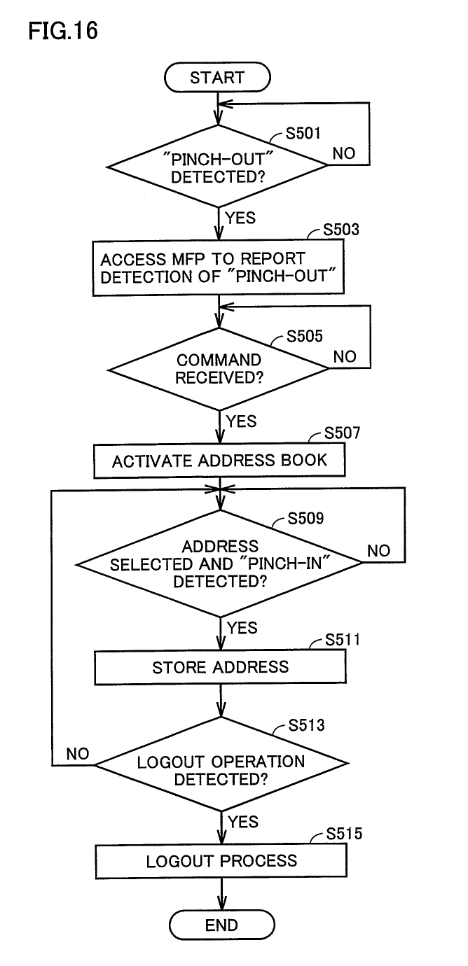

FIG. 16 is a flow chart showing an operation in portable terminal 300. The operation shown in the flow chart of FIG. 16 is also implemented by CPU 30 reading a program stored in ROM 31 and executing the program on RAM 32.

Referring to FIG. 16, when it is detected that a pinch-out gesture has been performed on operation panel 34 (YES in Step S501), CPU 30 in Step S503 accesses MFP 100 using the access information on MFP 100 previously stored, and reports that the pinch-out gesture has been performed.

At this time, MFP 100 transmits a stored command to portable terminal 300 in response to the above-described report. When the command is stored in MFP 100 in association with the pinch-in information, authentication may be carried out using user information and the like included in the above-described report, and the above-described command may be transmitted to portable terminal 300 when authentication has succeeded.

When portable terminal 300 receives the command from MFP 100 (YES in Step S505), CPU 30 in Step S507 activates the address book application in accordance with that command. It is noted that, when the application indicated by the command from MFP 100 is not mounted on portable terminal 300, CPU 30 preferably reports to that effect to MFP 100 as an issuer of that command.

When the address book application is activated and selection of an address from the list is received, and when it is detected that a pinch-in gesture has been performed at a position where the address information is displayed (YES in Step S509), CPU 30 in Step S511 identifies the address information having been subjected to the pinch-in gesture as address information to be transmitted, and stores it temporarily.

The above operation is repeated until a logout operation is detected (NO in Step S513). Therefore, a plurality of pieces of address information may be identified as the address information to be transmitted by the above-described operation performed several times until a logout operation is detected. Moreover, a plurality of pieces of address information may be identified as address information to be transmitted by a single pinch-in gesture in correspondence with a pinch-in gesture performed on a folder or on a plurality of pieces of address information.

When a logout operation is detected (YES in Step S513), CPU 30 executes a logout process in Step S5415, and terminates the sequential operation.

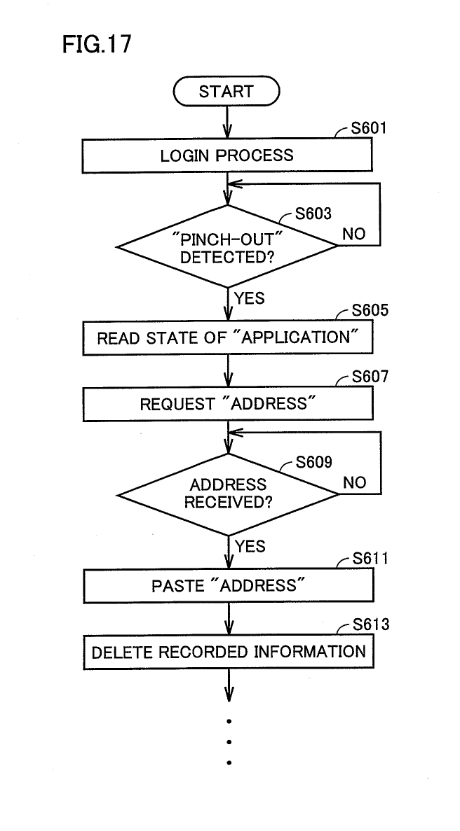

FIG. 17 is a flow chart showing an operation in MFP 100 in response to a pinch-out gesture. The operation shown in the flow chart of FIG. 17 is also implemented by CPU 10 reading a program stored in ROM 11 and executing the program on RAM 12.

Referring to FIG. 17, in Step S601, CPU 10 executes a login process by receiving a login operation. Then, when it is detected that a pinch-out gesture has been performed on operation panel 15 (YES in Step S603), CPU 10 in Step S605 reads the state of processing of the application temporarily stored in the above-described step S405, and causes processing of the application to be resumed from that state. That is, in Step S605, an e-mail transmission screen is displayed on operation panel 15, and the processing for e-mail transmission is resumed from address entry. Then, in Step S607, CPU 10 outputs a transmission request for address information to portable terminal 300 using the address information on portable terminal 300 previously registered.

At this time, when the information showing the state of processing of the application is stored in association with the pinch-in information, an authentication process may be performed based on the pinch-in information and the login information in the above-described step S601, and processing of the application may be resumed when authentication has succeeded.

When the address information is transmitted from portable terminal 300 in response to the above-described request (YES in Step S609), CPU 10 in Step S611 inputs an address based on the received address information to the address entry field to be displayed in the e-mail transmission screen on operation panel 15. CPU 10 in Step S613 deletes the above-described information showing the state of processing of the application stored temporarily.

Then, a process in accordance with an operation on the application is executed, and the sequential operation is terminated.

<Effects of Embodiment>

By the above-described operations being executed in the image forming system according to the second embodiment, it is possible to cause MFP 100 to acquire address information from portable terminal 300 by intuitive and continuous manipulations in e-mail transmission in MFP 100 to an address stored in portable terminal 300.

It is noted that, although the above example describes the application for e-mail transmission by way of example, any application may be used as long as it is an application for which processing is performed using information stored in another device, such as an application for facsimile transmission, for example.

Further, the above example describes that data shall be transmitted from portable terminal 300 to MFP 100 for use in MFP 100, by way of example, however, by exchanging MFP 100 and portable terminal 300 in the above description, data will be transmitted from MFP 100 to portable terminal 300 in a similar manner, and the data will be used in an application in portable terminal 300. Specifically, a request for address is sent to MFP 100 by a pinch-in gesture on the address entry field on the e-mail transmission screen displayed on operation panel 34 of portable terminal 300, the address book application is activated by a pinch-out gesture on MFP 100, address information to be transmitted is identified by a pinch-in gesture on the list display, address information is requested of MFP 100 by a pinch-out gesture on portable terminal 300, and is used for e-mail transmission in portable terminal 300. That is, in this case as well, the application can be executed using data in another device by intuitive and continuous manipulations.

Further, the device that transmits data to MFP 100 is not limited to portable terminal 300, but may be another MFP different from MFP 100. That is, data may be transmitted between two MFPs, from one MFP to the other MFP, and execution of an application may be resumed in the other MFP using the transmitted data. In that case, the other MFP 100 has the function shown in FIG. 14.

[Variation]

The first and second embodiments describe the examples in which data is transmitted between MFP 100 and portable terminal 300 or between two different MFPs.

However, data transmission is not limited to different devices, but may be made within a single device.

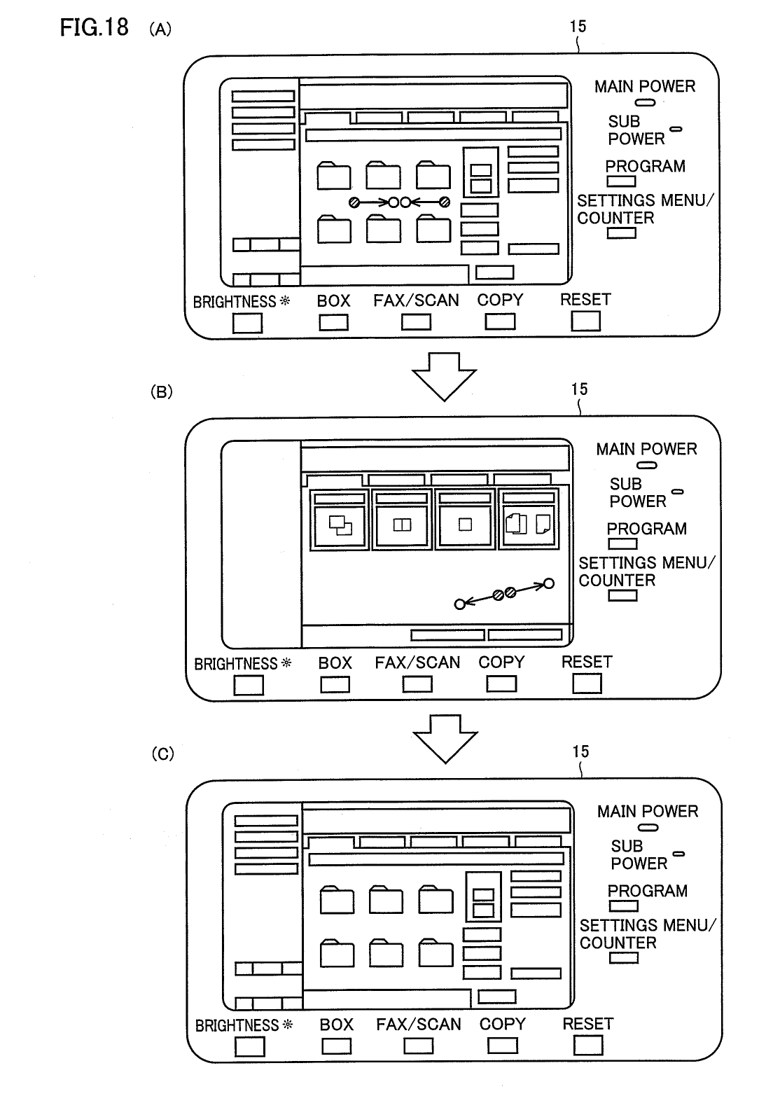

FIG. 18 illustrates a variation of data transmission according to the present embodiment. MFP 100 according to the variation includes the function shown in FIG. 14 as a function for making data transmission.

Referring to FIG. 18, in MFP 100, when it is detected that a pinch-in gesture has been performed on operation panel 15 (FIG. 18(A)) with an application being executed and a screen in accordance with that application being displayed on operation panel 15, CPU 10 temporarily stores information showing the state of processing of the application including the state of the display screen when the pinch-in gesture has been detected.

At this time, CPU 10 may identify information that identifies a login user or the like, for example, as information when the pinch-in gesture has been performed, and may store the pinch-in information in association with the above-described information showing the state of processing of the application.

Then, when it is detected that a pinch-out gesture has been performed on operation panel 15 (FIG. 18(B)), even if a different application is executed and a display screen therefor is displayed, for example, CPU 10 will read the information showing the state of processing of the application stored in response to the previous pinch-in gesture, and resume processing of the application from that state (FIG. 18(C)).

At this time, when the information showing the state of processing of the application has the pinch-in information associated therewith, CPU 10 may perform an authentication process for the login user when the pinch-out gesture has been performed, and may resume processing of the application when authentication has succeeded.

Thus, in the case where a situation arises in that a certain user shall temporarily leave MFP 100 while operating MFP 100, for example, the state of processing of the application at that time can be stored by an intuitive and easy manipulation, and processing of the application can thereafter be resumed from that state.

Further, a program for causing the operations in MFP 100 and the operations in portable terminal 300 described above to be performed can also be offered. Such a program can be recorded on a computer-readable recording medium, such as a flexible disk attached to a computer, a CD-ROM (Compact Disk-Read Only Memory), a ROM, a RAM, a memory card, or the like, and can be offered as a program product. Alternatively, a program can be offered as recorded on a recording medium such as a hard disk built in a computer. Still alternatively, the program can also be offered by downloading through a network.

It is noted that the program according to the present invention may cause the process to be executed by invoking a necessary module among program modules offered as part of an operating system (OS) of a computer with a predetermined timing in a predetermined sequence. In that case, the program itself does not include the above-described module, but the process is executed in cooperation with the OS. Such a program not including a module may also be covered by the program according to the present invention.

Moreover, the program according to the present invention may be offered as incorporated into part of another program. Also in such a case, the program itself does not include the module included in the above-described other program, and the process is executed in cooperation with the other program. Such a program incorporated into another program may also be covered by the program according to the present invention.

An offered program product is installed in a program storage unit, such as a hard disk, and is executed. It is noted that the program product includes a program itself and a recording medium on which the program is recorded.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image forming apparatus comprising:
a touch panel;
a controller connected to said touch panel; and
a memory, wherein
continuously after two contacts are made on said touch panel, when a first gesture of moving said two contacts in a direction that a spacing therebetween is decreased and then releasing said two contacts after being moved is detected during execution of a first application, said controller stores, in said memory, information showing a state of processing of said first application when said first gesture is detected, and
when a second gesture of moving said two contacts in a direction that the spacing therebetween is increased and then releasing said two contacts after being moved is detected on said touch panel, said controller reads said stored information showing the state of processing of said first application from said memory, and resumes processing of said first application from the state shown by said stored information.

2. The image forming apparatus according to claim 1, further comprising a communication device for communicating with an other device, wherein
when said first gesture is detected during execution of said first application, said controller outputs a command for causing said other device previously stored to execute a second application previously defined in correspondence with said first application, and
when said second gesture is detected, said controller sends a request for information from said other device to acquire said information transmitted from said other device in response to said request, and resumes processing of said first application using said information.

3. The image forming apparatus according to claim 2, wherein said controller outputs said command in accordance with the state of processing of said first application when said first gesture is detected.

4. The image forming apparatus according to claim 3, wherein
said controller outputs a command for causing said second application to be executed to request information corresponding to a position where said first gesture has been performed on a screen in accordance with execution of said first application when said first gesture is detected, and
when said second gesture is detected, said controller inputs the information acquired from said other device to a position on said first application corresponding to the position where said first gesture has been performed, and resumes processing of said first application.

5. The image forming apparatus according to claim 2, wherein
said controller performs user authentication using user information to store, in said memory, the information showing the state of processing of said first application in association with a user,
the information transmitted from said other device has a user associated therewith, and
when said second gesture is detected, said controller resumes processing of said first application using the information acquired from said other device in a case where the user associated with said information showing the state of processing of said first application matches the user associated with the information acquired from said other device.

6. The image forming apparatus according to claim 2, wherein
upon receipt of input of said command from said other device and when said second gesture is detected during execution of said second application indicated by said command, said controller identifies information displayed in an area defined by said two contacts at least either of before and after being moved as information to be transmitted to said other device, and transmits the information to said other device.

7. The image forming apparatus according to claim 1, wherein
said controller performs user authentication using user information to store, in said memory, the information showing the state of processing of said first application in association with a user, and
when said second gesture is detected, said controller resumes processing of said first application in a case where a login user in said second gesture matches the user associated with the information showing the state of processing of said first application.

8. A terminal device comprising:
a touch panel;
a controller connected to said touch panel; and
a communication device for communicating with an image forming apparatus, wherein
continuously after two contacts are made on said touch panel, when a first gesture of moving said two contacts in a direction that a spacing therebetween is decreased and then releasing said two contacts after being moved is detected during execution of a first application, said controller identifies information displayed by execution of said first application in an area defined by said two contacts at least either of before and after being moved as information to be transmitted, and outputs said information to be transmitted to said image forming apparatus.

9. The terminal device according to claim 8, wherein continuously after two contacts are made on said touch panel, when a second gesture of moving said two contacts in a direction that the spacing therebetween is increased and then releasing said two contacts after being moved is detected, said controller accesses said image forming apparatus previously stored to acquire a command at least identifying a second application to be executed from said image forming apparatus, and executes said second application in accordance with said command.

10. The terminal device according to claim 8, wherein continuously after two contacts are made on said touch panel, when a second gesture of moving said two contacts in a direction that the spacing therebetween is increased and then releasing said two contacts after being moved is detected, said controller accesses said image forming apparatus previously stored to request said information to be transmitted from said image forming apparatus.

11. An image forming system comprising:
an image forming apparatus; and
a terminal device,
said image forming apparatus and said terminal device each including a touch panel and a controller connected to said touch panel, wherein
continuously after two contacts are made on said touch panel, when a first gesture of moving said two contacts in a direction that a spacing therebetween is decreased and then releasing said two contacts after being moved is detected during execution of a first application, said controller of a first device out of said image forming apparatus and said terminal device stores information showing a state of processing of said first application when said first gesture is detected, and outputs a command for causing a second device out of said image forming apparatus and said terminal device to execute a second application previously defined in correspondence with said first application, and
when a second gesture of moving said two contacts in a direction that the spacing therebetween is increased and then releasing said two contacts after being moved is detected on said touch panel, said controller of said first device sends a request for information from said second device to acquire said information transmitted from said second device in response to said request, and using said information, resumes processing of said first application from the state shown by said stored information showing the state of processing of said first application.

12. The image forming system according to claim 11, wherein
said first device further includes a communication device for communicating with said second device, and
when said first gesture is detected during execution of said first application, said controller of said first device outputs said command for causing said second device previously stored to execute said second application, and
when said second gesture is detected, said controller of said first device sends said request for information from said second device to acquire said information transmitted from said second device in response to said request, and resumes processing of said first application using said information.

13. The image forming system according to claim 12, wherein said controller of said first device outputs said command in accordance with the state of processing of said first application when said first gesture is detected.

14. The image forming system according to claim 13, wherein
said controller of said first device outputs a command for causing said second application to be executed to request information corresponding to a position where said first gesture has been performed on a screen in accordance with execution of said first application when said first gesture is detected, and
when said second gesture is detected, said controller of said first device inputs the information acquired from said second device to a position on said first application corresponding to the position where said first gesture has been performed, and resumes processing of said first application.

15. The image forming system according to claim 12, wherein
said controller of said first device performs user authentication using user information to store the information showing the state of processing of said first application in association with a user,
the information transmitted from said second device has a user associated therewith, and
when said second gesture is detected, said controller of said first device resumes processing of said first application using the information acquired from said second device in a case where the user associated with the information showing the state of processing of said first application matches the user associated with the information acquired from said second device.

16. The image forming system according to claim 12, wherein
upon receipt of input of said command from said second device and when said second gesture is detected during execution of said second application indicated by said command, said controller of said first device identifies information displayed in an area defined by said two contacts at least either of before and after being moved as information to be transmitted to said second device, and transmits the information to said second device.

17. The image forming system according to claim 11, wherein
said controller of said first device performs user authentication using user information to store the information showing the state of processing of said first application in association with a user, and
when said second gesture is detected, said controller of said first device resumes processing of said first application in a case where a login user in said second gesture matches the user associated with the information showing the state of processing of said first application.

18. A non-transitory computer-readable storage medium having recorded thereon a program for causing an image processing apparatus having a touch panel and a controller connected to said touch panel to execute a first application, wherein said program instructs said controller to perform the following steps of:
continuously after two contacts are made on said touch panel, detecting a first gesture of moving said two contacts in a direction that a spacing therebetween is decreased and then releasing said two contacts after being moved during execution of said first application;
when said first gesture is detected during execution of said first application, storing information showing a state of processing of said first application when said first gesture is detected, and outputting a command for causing an other device to execute a second application previously defined in correspondence with said first application;
after detection of said first gesture, detecting a second gesture of moving said two contacts in a direction that the spacing therebetween is increased and then releasing said two contacts after being moved;
when said second gesture is detected after the detection of said first gesture, sending a request for information from said other device;
acquiring said information transmitted from said other device in response to said request; and
resuming processing of said first application from the state shown by said stored information, using the information acquired from said other device.

19. A non-transitory computer-readable storage medium having recorded thereon a program for causing a terminal device having a touch panel and a controller connected to said touch panel to execute a process of transmitting information stored in the terminal device to an image processing apparatus, wherein said program instructs said controller to perform the following steps of:
continuously after two contacts are made on said touch panel, detecting a first gesture of moving said two contacts in a direction that a spacing therebetween is increased and then releasing said two contacts after being moved;
reporting detection of said first gesture to said image processing apparatus, thereby acquiring a command from said image processing apparatus;
executing an application identified by said command;
during execution of said application, continuously after two contacts are made on said touch panel, detecting a second gesture of moving said two contacts in a direction that the spacing therebetween is decreased and then releasing said two contacts after being moved;
when said second gesture is detected, identifying information displayed by execution of said application in an area defined by said two contacts at least either of before and after being moved as information to be transmitted; and
outputting said information to be transmitted to said image processing apparatus in response to a request from said image processing apparatus.
